(19) United States
(12) Patent Application Publication
(10) Pub. No.: US 2024/0312684 A1
(43) Pub. Date: Sep. 19, 2024

(54) COIL COMPONENT

(71) Applicant: TDK Corporation, Tokyo (JP)

(72) Inventors: Ryuji Hashimoto, Tokyo (JP); Nobuyuki Okuzawa, Tokyo (JP); Yuta Takahashi, Tokyo (JP); Hiroki Hosaka, Tokyo (JP); Munehiro Takaku, Tokyo (JP); Shinnosuke Suzuki, Tokyo (JP)

(73) Assignee: TDK Corporation, Tokyo (JP)

(21) Appl. No.: 18/404,404

(22) Filed: Jan. 4, 2024

(30) Foreign Application Priority Data
Mar. 17, 2023 (JP) 2023-043012

(51) Int. Cl. H01F 5/06; H01F 5/04

(52) U.S. Cl. CPC H01F 5/06; H01F 5/04

(57) ABSTRACT

A coil component includes an element body formed by stacking a plurality of insulating layers and including a principal surface and a principal surface, a first terminal electrode and a second terminal electrode disposed on the principal surface of the element body, and a coil disposed in the element body and electrically connected to the first terminal electrode and the second terminal electrode. The coil includes a first wiring portion disposed on the principal surface side, a second wiring portion disposed on the principal surface side, and a pillar portion extending in the second direction and connecting the first wiring portion and the second wiring portion. In the pillar portion, a filler is disposed on a contact surface in which two conductors come into contact with each other.

### TECHNICAL FIELD

The present disclosure relates to a coil component.

### BACKGROUND

Japanese Unexamined Patent Publication No. 2015-141945 discloses a coil component that includes an insulator made of resin, a coil provided in the insulator, and a terminal electrode electrically connected to the coil and disposed on an implementation surface of an element body. The coil includes a first wiring portion, a second wiring portion, and a connection portion connecting the first wiring portion and the second wiring portion.

### SUMMARY

An object of an aspect of the present disclosure is to provide a coil component capable of improving bonding strength of a portion where two conductors come into contact with each other in a connection portion.

(1) A coil component according to an aspect of the present disclosure includes an element body formed by stacking a plurality of insulating layers and including an implementation surface and a principal surface facing the implementation surface, a pair of terminal electrodes disposed on the implementation surface of the element body, and a coil disposed in the element body, and is electrically connected to the pair of terminal electrodes. The coil includes a first wiring portion disposed on the principal surface side, a second wiring portion disposed on the implementation surface side, and a connection portion extending in a facing direction of the implementation surface and the principal surface and connecting the first wiring portion and the second wiring portion, and in the connection portion, a filler is disposed on a contact surface where two conductors come into contact with each other.

In the coil component according to the aspect of the present disclosure, the filler is disposed on the contact surface of the connection portion where two conductors come into contact with each other. The contact surface may be a surface where the connection portion (conductor) and the first wiring portion (conductor) come into contact with each other, or two members (conductors) may be contact surfaces in a case where the connection portion is formed by stacking the plurality of members. In the coil component, since the filler is disposed on the contact surface, irregularities are provided on the contact surface. Thus, in the coil component, adhesion between the two conductors is improved by an anchor effect. Accordingly, in the coil component, the bonding strength of the portion where the two conductors come into contact with each other at the connection portion can be improved.

(2) In the coil component of the above (1), when the contact surface is viewed from the facing direction, a density of the filler disposed in an outer edge region of the contact surface may be higher than a density of the filler disposed in an inner region of the contact surface. In this configuration, since many fillers are disposed in the outer edge region of the contact surface, in a case where an external force is applied to the connection portion between the two conductors, stress can be effectively relieved (absorbed) by the fillers. Accordingly, in the coil component, the bonding strength of the portion where the two conductors come into contact with each other at the connection portion can be improved.

(3) In the coil component of the above (1) or (2), the filler may be disposed within a range of ±5 μm in the facing direction on the contact surface. In this configuration, the anchor effect can be effectively obtained.

(4) In the coil component according to any one of the above (1) to (3), an abundance ratio of the filler to an area of the contact surface may be 0.05% or more. In this configuration, the anchor effect can be obtained by the filler.

(5) In the coil component according to any one of the above (1) to (4), a plurality of the fillers may include a normal filler and a broken filler in which a part of the normal filler is broken. The normal filler is a filler that holds a prototype of the filler, and has, for example, a spherical shape. The broken filler is a filler in which a part of the normal filler is broken. The broken filler has a corner portion or the like due to breaking. In this configuration, the anchor effect can be effectively obtained.

(6) In the coil component according to any one of the above (1) to (5), the filler may be an insulating filler having electrical insulation. The insulating filler has higher hardness than the conductive filler having conductivity. Thus, since the filler is hardly deformed, a high anchor effect can be obtained. Accordingly, it is possible to further improve the bonding strength of the portion where the two conductors come into contact with each other in the connection portion.

According to the aspect of the present disclosure, it is possible to improve the bonding strength of the portion where the two conductors come into contact with each other in the connection portion.

### BRIEF DESCRIPTION OF THE DRAWINGS

FIG. 1 is a perspective view of a coil component according to an embodiment;

FIG. 2 is a diagram of the coil component illustrated in FIG. 1 as viewed from an end surface side;

FIG. 3A is an enlarged schematic cross-sectional view illustrating a connection portion between a first wiring portion and a pillar portion; and FIG. 3B is a schematic view illustrating a contact surface.

### DETAILED DESCRIPTION

Hereinafter, preferred embodiments of the present disclosure will be described in detail with reference to the accompanying drawings. Note that, the same or corresponding elements in the description of the drawings are denoted by the same reference signs, and redundant description is omitted.

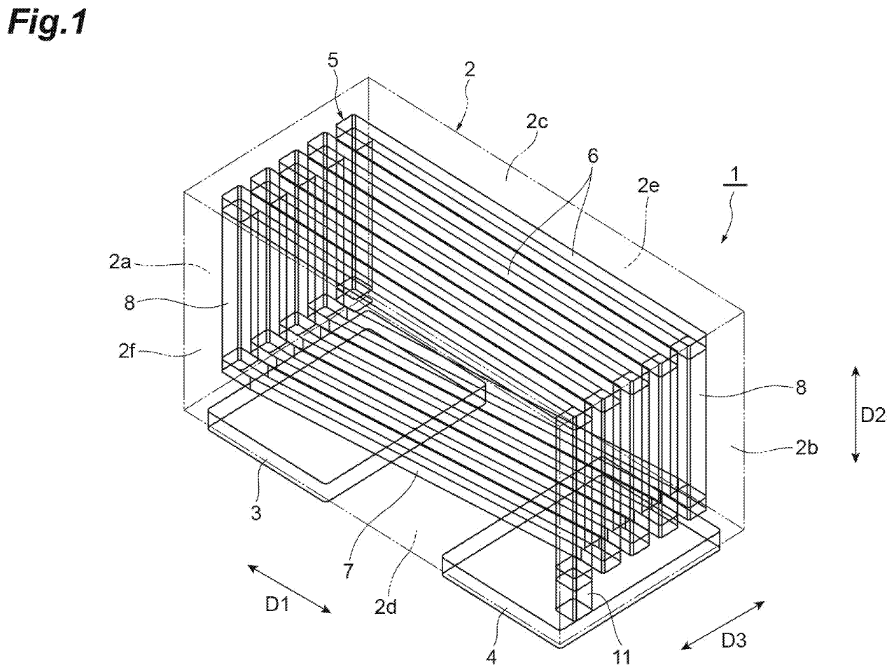

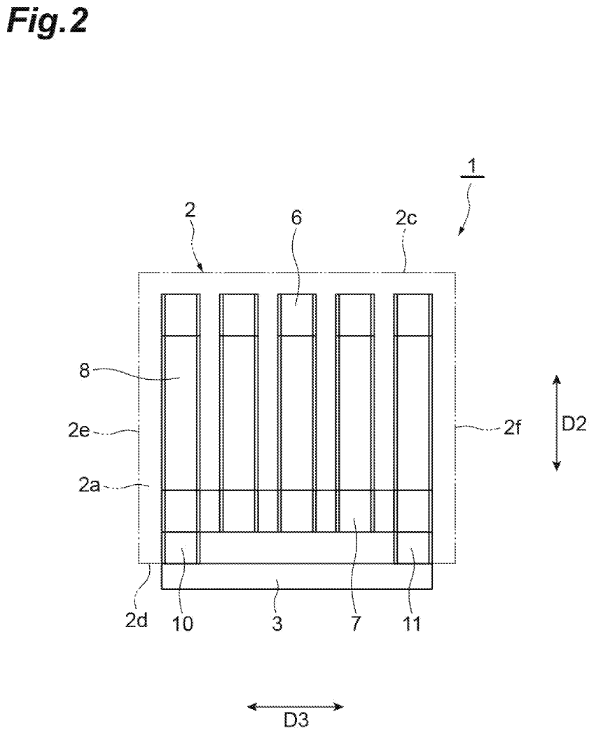

A coil component according to the present embodiment will be described with reference to FIG. 1. FIG. 1 is a perspective view of a coil component according to an embodiment. As illustrated in FIG. 1, a coil component 1 includes an element body 2, a first terminal electrode 3 and a second terminal electrode 4, a coil 5, a first connection conductor 10 (see FIG. 2), and a second connection conductor 11. In FIGS. 1 and 2, the element body 2 is indicated by a dashed double-dotted line. In FIG. 1, the coil 5 is illustrated in a transparent manner.

The element body 2 has, for example, a rectangular parallelepiped shape. The rectangular parallelepiped shape includes a rectangular parallelepiped shape in which corner portions and ridge line portions are chamfered, or a rectangular parallelepiped shape in which corner portions and ridge line portions are rounded. The element body 2 has, as outer surfaces, a pair of end surfaces 2a and 2b, a pair of principal surfaces 2c and 2d, and a pair of side surfaces 2e and 2f. The end surfaces 2a and 2b face each other. The principal surfaces 2c and 2d face each other. The side surfaces 2e and 2f face each other. Hereinafter, a facing direction of the end surfaces 2a and 2b is referred to as a first direction D1, a facing direction of the principal surfaces 2c and 2d is referred to as a second direction D2, and a facing direction of the side surfaces 2e and 2f is referred to as a third direction D3. The first direction D1, the second direction D2, and the third direction D3 are substantially orthogonal to each other.

The end surfaces 2a and 2b extend in the second direction D2 to connect the principal surfaces 2c and 2d. The end surfaces 2a and 2b also extend in the third direction D3 to connect the side surfaces 2e and 2f. The principal surfaces 2c and 2d extend in the first direction D1 to connect the end surfaces 2a and 2b. The principal surfaces 2c and 2d also extend in the third direction D3 to connect the side surfaces 2e and 2f. The side surfaces 2e and 2f extend in the first direction D1 to connect the end surfaces 2a and 2b. The side surfaces 2e and 2f also extend in the second direction D2 to connect the principal surfaces 2c and 2d.

The principal surface 2d is an implementation surface, and is, for example, a surface facing another electronic device (for example, circuit substrate or coil component) when the coil component 1 is mounted on the other electronic device (not illustrated). The end surfaces 2a and 2b are surfaces continuous from the implementation surface (that is, principal surface 2d).

In the case of the forms illustrated in FIGS. 1 and 2, a length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, the end surfaces 2a and 2b, the principal surfaces 2c and 2d, and the side surfaces 2e and 2f have a rectangular shape. The length of the element body 2 in the second direction D2 may be equal to the length of the element body 2 in the third direction D3, or may be longer than the length of the element body 2 in the third direction D3.

Note that, in the present embodiment, “equal” may be equal to a value including a slight difference or a manufacturing error in a preset range in addition to being equal. For example, when a plurality of values are included within a range of +5% of an average value of the plurality of values, the plurality of values are defined to be equal.

The element body 2 is formed by stacking a plurality of element body layers (insulating layers) in the second direction D2. That is, a stacking direction of the element body 2 is the second direction D2. In the actual element body 2, the plurality of element body layers may be integrated to such an extent that boundaries between the layers cannot be visually recognized, or may be integrated such that boundaries between the layers can be visually recognized.

The element body layer may be, for example, a resin layer. A material of the element body layer includes, for example, at least one selected from a liquid crystal polymer, a polyimide resin, crystalline polystyrene, an epoxy resin, an acrylic resin, a bismaleimide-based resin, and a fluorine-based resin. The element body layer may include a filler. The filler may be, for example, an inorganic filler. Examples of the inorganic filler include silica (SiO₂). Note that, the element body layer may not include a filler.

Note that, the element body layer may include a magnetic material. The magnetic material of the element body layer includes, for example, a Ni—Cu—Zn-based ferrite material, a Ni—Cu—Zn—Mg-based ferrite material, or a Ni—Cu-based ferrite material. The magnetic material of the element body layer may include, for example, an Fe alloy. The element body layer may contain, for example, a non-magnetic material. The non-magnetic material of the element body layer includes, for example, a glass ceramic material or a dielectric material.

Each of the first terminal electrode 3 and the second terminal electrode 4 is provided in the element body 2. Each of the first terminal electrode 3 and the second terminal electrode 4 is disposed on the principal surface 2d of the element body 2. The first terminal electrode 3 and the second terminal electrode 4 are provided in the element body 2 to be apart from each other in the first direction D1. Specifically, the first terminal electrode 3 is disposed on the end surface 2a side of the element body 2. The second terminal electrode 4 is disposed on the end surface 2b side of the element body 2.

Each of the first terminal electrode 3 and the second terminal electrode 4 may have, for example, a rectangular shape (quadrilateral shape). Each of the first terminal electrode 3 and the second terminal electrode 4 is disposed such that each side is along the first direction D1 or the third direction D3. As illustrated in FIG. 2, the first terminal electrode 3 and the second terminal electrode 4 protrude from the principal surface 2d. That is, in the present embodiment, surfaces of the first terminal electrode 3 and the second terminal electrode 4 are not flush with the principal surface 2d. The first terminal electrode 3 and the second terminal electrode 4 are made of a conductive material (for example, Cu).

A plating layer (not illustrated) containing, for example, Ni, Sn, Au, or the like may be provided in each of the first terminal electrode 3 and the second terminal electrode 4 by electrolytic plating or electroless plating. The plating layer may have, for example, a Ni plating film containing Ni and covering the first terminal electrode 3 and the second terminal electrode 4, and an Au plating film containing Au and covering the Ni plating film.

As illustrated in FIGS. 1 and 2, the coil 5 is disposed in the element body 2. The coil 5 includes a plurality of first wiring portions 6, a plurality of second wiring portions 7, and a plurality of pillar portions (connection portions) 8. The coil 5 is formed by electrically connecting the first wiring portion 6, the second wiring portion 7, and the pillar portion 8. A coil axis of the coil 5 is provided along the third direction D3. The plurality of first wiring portions 6, the plurality of second wiring portions 7, and the plurality of pillar portions 8 are made of a conductive material (for example, Cu). The first wiring portion 6, the second wiring portion 7, and the pillar portion 8 are disposed apart from the end surfaces 2a and 2b, the principal surfaces 2c and 2d, and the side surfaces 2e and 2f.

Each of the first wiring portions 6 is disposed on the principal surface 2c side of the element body 2. Each of the first wiring portions 6 extends along the first direction D1. Each of the first wiring portions 6 connects two pillar portions 8. The first wiring portion 6 is stretched between the two pillar portions 8. One end portion (end portion on the end surface 2a side) of the first wiring portion 6 in the extending direction is connected to one end portion (end portion on the principal surface 2c side) of the pillar portion 8. The other end portion (end portion on the end surface 2b side) of the first wiring portion 6 in the extending direction is connected to one end portion (end portion on the principal surface 2c side) of the pillar portion 8.

Each of the second wiring portions 7 is disposed on the principal surface 2d (mounting surface) side of the element body 2. Each of the second wiring portions 7 extends in the first direction D1. Each of the second wiring portions 7 connects two pillar portions 8. The second wiring portion 7 is stretched between the two pillar portions 8. One end portion (end portion on the end surface 2a side) of the second wiring portion 7 in the extending direction is connected to the other end portion (end portion on the principal surface 2d side) of the pillar portion 8. The other end portion (end portion on the end surface 2b side) of the second wiring portion 7 in the extending direction is connected to the other end portion (end portion on the principal surface 2d side) of the pillar portion 8. The number of the plurality of second wiring portions 7 is one less than the number of the plurality of first wiring portions 6. That is, in a case where the number of the first wiring portions 6 is n, the number of the second wiring portions 7 is n-1.

The first connection conductor 10 connects the first terminal electrode 3 and one end portion of the coil 5. The first connection conductor 10 is connected to the other end portion of the pillar portion 8 of the coil 5. The first connection conductor 10 is disposed at a position close to the end surface 2a and close to the side surface 2e. The first connection conductor 10 is made of a conductive material. The first connection conductor 10 is formed of, for example, Cu.

The second connection conductor 11 connects the second terminal electrode 4 and the other end portion of the coil 5. The second connection conductor 11 is connected to the other end portion of the pillar portion 8 of the coil 5. The second connection conductor 11 is disposed at a position close to the end surface 2b and close to the side surface 2f. The second connection conductor 11 is made of a conductive material. The second connection conductor 11 is formed of, for example, Cu.

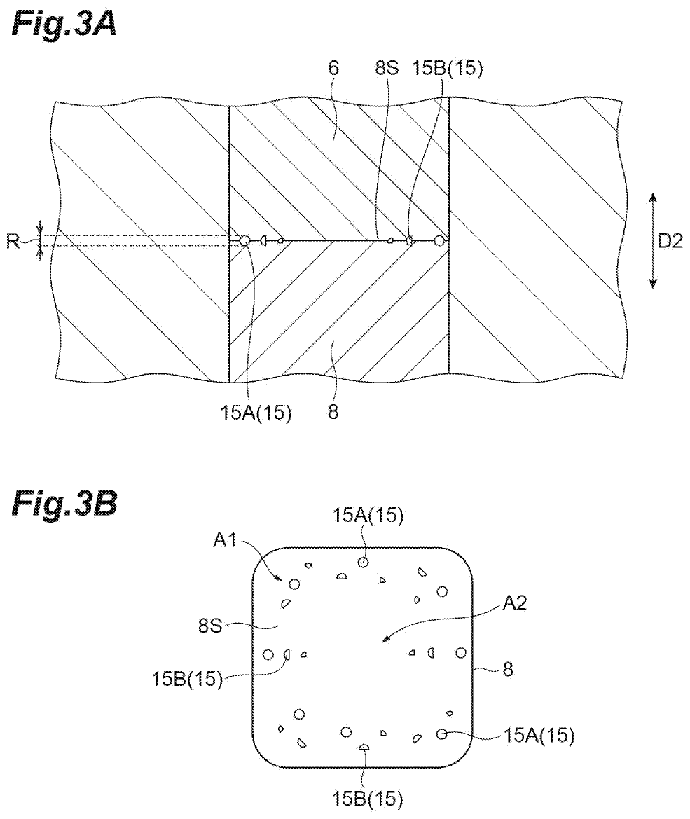

FIG. 3A is an enlarged schematic cross-sectional view illustrating a connection portion between the first wiring portion 6 and the pillar portion 8, and FIG. 3B is a schematic view illustrating a contact surface. As illustrated in FIGS. 3A and 3B, the pillar portion 8 has a contact surface 8S. The contact surface 8S is a surface where two conductors come into contact with each other in the pillar portion 8. In the example illustrated in FIG. 3A, the contact surface 8S where the first wiring portion 6 and the pillar portion 8 come into contact with each other is illustrated, but the pillar portion 8 may have another contact surface. Specifically, in a case where the pillar portion 8 includes a plurality of members (components) (formed by stacking a plurality of members), the pillar portion has a contact surface where two members (conductors) come into contact with each other. In the pillar portion 8, the contact surface 8S coming into contact with the first wiring portion 6 is an upper end surface of the pillar portion 8.

A plurality of fillers 15 are disposed on the contact surface 8S. The plurality of fillers 15 may be insulating fillers having electrical insulation or conductive fillers having conductivity. In the present embodiment, the plurality of fillers 15 are insulating fillers. Examples of the insulating filler include silica (SiO₂). The plurality of fillers 15 may include a normal filler 15A and a broken filler 15B. The normal filler 15A is a filler that holds a prototype of the filler. The normal filler 15A has, for example, a spherical shape. The broken filler 15B is a filler in which a part of the normal filler 15A is broken (prototype is not retained). The broken filler 15B has a corner portion and the like. An average particle diameter of the filler 15 is, for example, 0.5 μm.

As illustrated in FIG. 3B, when the contact surface 8S is viewed from the second direction D2, a density of the filler 15 disposed in an outer edge region A1 of the contact surface 8S is higher than a density of the filler 15 disposed in an inner region A2 of the contact surface 8S. That is, in the contact surface 8S, many fillers 15 are disposed more in the outer edge region A1 than in the inner region A2. In other words, the density of the filler 15 disposed in the inner region A2 of the contact surface 8S is lower than the density of the filler 15 disposed in the outer edge region A1 of the contact surface 8S. In the contact surface 8S, it can be said that an area of the filler 15 per unit area in the outer edge region A1 is larger than an area of the filler 15 per unit area in the inner region A2.

The filler 15 has a portion protruding closer to the principal surface 2c than the contact surface 8S and a portion buried closer to the principal surface 2d than the contact surface 8S. As illustrated in FIG. 3A, the filler 15 is disposed within a predetermined range R in the second direction D2 on the contact surface 8S. The predetermined range R is +5 μm with respect to the contact surface 8S. In the contact surface 8S, a portion around the filler 15 may be recessed more than the contact surface 8S. The contact surface 8S has an uneven shape by disposing the filler 15.

In the present embodiment, an abundance ratio of the filler 15 to the area of the contact surface 8S is 0.05% or more and 88.9% or less. In the pillar portion 8, the filler 15 is not disposed in a portion other than the contact surface 8S (a portion other than the predetermined range R). That is, the filler 15 is not disposed in the entire pillar portion 8.

The coil component 1 can be manufactured, for example, as follows. The element body 2 can be formed by laminating a sheet constituting the element body layer. The coil 5 (first wiring portion 6, second wiring portion 7, and pillar portion 8), the first connection conductor 10, and the second connection conductor 11 can be manufactured by using a photolithography method. The “photolithography method” is not limited to a type of a mask or the like as long as a layer to be processed containing a photosensitive material is processed into a desired pattern by exposing and developing the layer.

For example, after the conductor constituting the pillar portion 8 is formed by a photolithography method, the sheet constituting the element body layer is laminated. Subsequently, the sheet is polished by grind polishing to expose and planarize the conductor. Subsequently, a sheet containing the filler 15 is laminated to include an exposed surface of the conductor. Then, the sheet is polished by grind polishing. As a result, the filler 15 contained in the sheet enters (pierces) the exposed surface of the conductor, and the filler 15 is disposed on the exposed surface (contact surface 8S). At the time of grind polishing, a part of the filler 15 is broken, and the broken filler 15B is provided. This processing is repeated a predetermined number of times, and thus, the pillar portion 8 is formed.

As described above, in the coil component 1 according to the present embodiment, in the pillar portion 8, the filler 15 is disposed on the contact surface 8S where two conductors come into contact with each other. The contact surface 8S may be a surface where the pillar portion 8 and the first wiring portion 6 come into contact with each other, or two members among a plurality of members constituting the pillar portion 8 are contact surfaces. In the coil component 1, since the filler is disposed on the contact surface 8S, irregularities are provided on the contact surface 8S. Thus, in the coil component 1, the adhesion between the two conductors is improved by the anchor effect.

Accordingly, in the coil component 1, bonding strength of the portion where the two conductors come into contact with each other in the pillar portion 8 can be improved.

In the coil component 1 according to the present embodiment, when the contact surface 8S is viewed from the facing direction, the density of the filler 15 disposed in the outer edge region A1 of the contact surface 8S is higher than the density of the filler 15 disposed in the inner region A2 of the contact surface 8S. In this configuration, since many fillers 15 are disposed in the outer edge region A1 of the contact surface 8S, in a case where an external force is applied to a connection portion between the two conductors, the filler 15 can effectively relieve (absorb) stress. Accordingly, in the coil component 1, bonding strength of the portion where the two conductors come into contact with each other in the pillar portion 8 can be improved.

In the coil component 1 according to the present embodiment, the filler 15 is disposed within a range of +5 μm in the second direction D2 on the contact surface 8S. In this configuration, the anchor effect can be effectively obtained.

In the coil component 1 according to the present embodiment, the abundance ratio of the filler 15 to the area of the contact surface 8S is 0.05% or more and 88.9% or less. The abundance ratio of the filler 15 is set to 0.05% or more, and thus, the anchor effect can be obtained. The abundance ratio of the filler 15 is set to 88.9% or less, and thus, conductivity of the pillar portion 8 can be secured even in a case where the filler 15 is an insulating filler.

In the coil component 1 according to the present embodiment, the plurality of fillers 15 include the normal filler 15A and the broken filler 15B in which a part of the normal filler 15A is broken. The normal filler 15A is a filler that holds the prototype of the filler, and has, for example, a spherical shape. In the broken filler 15B, a part of the normal filler 15A is broken. The broken filler 15B has a corner portion or the like due to breaking. In this configuration, the anchor effect can be effectively obtained.

In the coil component 1 according to the present embodiment, the filler 15 is an insulating filler having electrical insulation. The insulating filler has higher hardness than the conductive filler having conductivity. Thus, since the filler 15 is hardly deformed, a high anchor effect can be obtained. Accordingly, it is possible to further improve the bonding strength of the portion where the two conductors come into contact with each other in the pillar portion 8.

Although the embodiment of the present disclosure has been described above, the present disclosure is not necessarily limited to the above-described embodiment, and various modifications can be made without departing from the gist thereof.

In the above embodiment, in a case where the pillar portion 8 has the plurality of contact surfaces 8S, the filler 15 may be disposed on at least one contact surface 8S.

In the above embodiment, a mode in which the filler 15 is an insulating filler has been described by way of example. However, the filler 15 may be a conductive filler.

In the above embodiment, when the contact surface 8S is viewed from the facing direction, a mode in which the density of the filler 15 disposed in the outer edge region A1 of the contact surface 8S is higher than the density of the filler 15 disposed in the inner region A2 of the contact surface 8S has been described as an example. However, the disposition form of the filler 15 on the contact surface 8S is not limited thereto. For example, the filler 15 may be evenly disposed on the contact surface 8S.

In the above embodiment, the configuration of the coil 5 is not limited to the form illustrated in FIGS. 1 and 2.

In the above embodiment, a mode in which each of the first terminal electrode 3 and the second terminal electrode 4 is disposed on the principal surface 2d of the element body 2 has been described as an example. However, the first terminal electrode 3 and the second terminal electrode 4 may be partially embedded in an opening provided in the principal surface 2d.

What is claimed is:

1. A coil component comprising:
an element body formed by stacking a plurality of insulating layers and including an implementation surface and a principal surface facing the implementation surface;
a pair of terminal electrodes disposed on the implementation surface of the element body; and
a coil disposed in the element body, and is electrically connected to the pair of terminal electrodes, wherein
the coil includes a first wiring portion disposed on the principal surface side, a second wiring portion disposed on the implementation surface side, and a connection portion extending in a facing direction of the implementation surface and the principal surface and connecting the first wiring portion and the second wiring portion, and
in the connection portion, a filler is disposed on a contact surface where two conductors come into contact with each other.

2. The coil component according to claim 1, wherein when the contact surface is viewed from the facing direction, a density of the filler disposed in an outer edge region of the contact surface is higher than a density of the filler disposed in an inner region of the contact surface.

3. The coil component according to claim 1, wherein the filler is disposed within a range of ±5 μm in the facing direction on the contact surface.

4. The coil component according to claim 1, wherein an abundance ratio of the filler to an area of the contact surface is 0.05% or more.

5. The coil component according to claim 1, wherein a plurality of the fillers include a normal filler and a broken filler in which a part of the normal filler is broken.

6. The coil component according to claim 1, wherein the filler is an insulating filler having electric insulation.
